(19) United States
(12) Patent Application Publication
(10) Pub. No.: US 2025/0386130 A1
(43) Pub. Date: Dec. 18, 2025

(54) PREDICTION AND CORRECTION OF SOUND PRESSURE AT AN EARDRUM

(71) Applicant: HARMAN INTERNATIONAL INDUSTRIES, INCORPORATED, Stamford, CT (US)

(72) Inventors: Etienne Thierry Jean-Luc RIVET, Pully (CH); Todd S. WELTI, Thousand Oaks, CA (US); Jeffrey Ross BAKER, Thousand Oaks, CA (US); Sean Edward OLIVE, Oak Park, CA (US)

(21) Appl. No.: 19/233,792

(22) Filed: Jun. 10, 2025

Related U.S. Application Data
(60) Provisional application No. 63/659,990, filed on Jun. 14, 2024.

(51) Int. Cl. H04R 1/10; G10K 11/178

(52) U.S. Cl. CPC H04R 1/1083; G10K 11/17813; G10K 2210/1081; G10K 2210/3035; G10K 2210/504; H04R 1/1016; H04R 2460/01; H04R 2460/15

(57) ABSTRACT

Various embodiments disclose a computer-implemented method that can include driving an audio output device to reproduce a stimulus signal when a wearable device is placed along an ear canal of a user, receiving a sound signal from a microphone based on the stimulus signal, and determining, based on the sound signal and a calculated response of the microphone retrieved from a memory, one or more characteristics of the ear canal of the user, wherein the one or more characteristics of the ear canal comprises an ear canal impedance, and applying, based on the one or more characteristics of the ear canal, an ear canal response correction to an output signal played back by the audio output device.

### CROSS-REFERENCE TO RELATED APPLICATIONS

This application claims priority benefit to U.S. Provisional Application No. 63/659,990, filed Jun. 14, 2024 and entitled “PREDICTION AND CORRECTION OF SOUND PRESSURE AT AN EARDRUM.” The contents of this application are incorporated by reference herein in its entirety.

### BACKGROUND

### Field of the Various Embodiments

The various embodiments relate generally to audio systems and, more specifically, to prediction and correction of sound pressure at an eardrum.

### Description of the Related Art

Earbuds are used to play back music, voice, or other audio signals. Modern earbuds are often implemented with noise cancellation, hear-through or transparency-mode features, and other audio personalization features. However, the shape of users' ear canals and the acoustic impedance of users' eardrums are variable. As a result, the same sound produced by an earbud can be perceived very differently by different users depending on the variation in the ear anatomy of different users. These variations in hearing perception have significant impacts on various aspects of the listening experience. For example, timbre, spatial audio quality, the performance of active noise cancellation (ANC), and the quality of hear-through or transparency functions are all affected based on these variations.

One drawback associated with conventional earbuds is that they typically use a one-size-fits-all approach to implement various features, such as those identified above. For example, the sound output by a conventional earbud is often calibrated by use of an ear simulator that represents the average of the ear canal shape and/or eardrum impedance of a population of users. The ear simulator typically conforms to standardized size or response parameters of an ear canal or eardrum. However, different users have different physical characteristics with respect to ear canal anatomy and eardrum acoustic impedances. Consequently, an earbud that utilizes a one-size-fits all approach to calibration can produce sound characteristics that are unsuitable or undesirable by different users with varying ear characteristics.

As the foregoing illustrates, what is needed in the art are more effective techniques for adaptive tailoring of various features of a earbuds in accordance with the unique ear anatomy of different users.

### SUMMARY

In various embodiments, a computer-implemented method comprises driving an audio output device to reproduce a stimulus signal when a wearable device is placed along an ear canal of a user, receiving a sound signal from a microphone based on the stimulus signal, and determining, based on the sound signal, one or more characteristics of the ear canal of the user.

Further embodiments provide, among other things, one or more non-transitory computer-readable media and systems configured to implement the method set forth above.

At least one technical advantage of the disclosed techniques herein relative to the prior art is that, with the disclosed techniques, a quality of sound produced by an earbud can be tailored in accordance with different physical attributes of a user's ear canal and eardrum. Additionally, the sound can be tailored to a user without having to directly measure the response of a user's eardrum and without placing microphones or sensors on the eardrum of the user. Instead, the disclosed techniques customize the sound quality of an earbud in response to sound detected by one or more internal microphones of the earbud that serve other purposes, such as one or more microphones that facilitate active noise cancellation. Another advantage of the disclosed techniques is providing for practical measurement and characterization of individual ear canal behavior and prediction of actual acoustic response at user's eardrum. Calculating the acoustic response of the user's eardrum allows for the effects of a user's ear canal and eardrum on acoustic performance to be corrected and individualized. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, can be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a block diagram of an example audio system configured to implement one or more aspects of the present disclosure;

FIG. 2 illustrates an example of an audio system, represented as an earbud, according to various embodiments;

FIG. 3 illustrates a representation of a two-port network implemented by the controller application of FIG. 1 that characterizes the behavior of the audio system according to various embodiments;

FIG. 4 illustrates the two two-port networks T_{EP} and T_{EP2} implemented by controller application shown with an unknown acoustic load Z_{EC}(ω) that represents the ear canal according to various embodiments;

FIG. 5 illustrates an example measurement of the one or more microphones performed by controller application according to various embodiments;

FIG. 6 illustrates an example of a plot showing a calculation of Z_{EC}(ω) at the ear tip 206 of an audio system according to various embodiments;

FIG. 7 illustrates an example of a plot showing the calculation PEP (@) at the ear tip 206 of an audio system according to various embodiments;

FIG. 8 illustrates a plot showing the ear input admittance Y_{EC}(ω) according to various embodiments;

FIG. 9 illustrates a plot that shows the summation of H_{P}_{_{DRP}}_{/P}_{_{EP}}(ω) from individual filters that are built from the modal parameters according to various embodiments;

FIG. 10 illustrates a plot showing a comparison of the ear tip to ear drum transfer function shown with a transfer function of the measured pressure P_{DRP}(ω) response at the drum reference point relative to the pressure P_{EP}(ω) response according to various embodiments;

FIG. 11 illustrates a plot showing a predicted pressure at a drum reference point with the actual measured pressure in the ear simulator, according to various embodiments;

FIG. 12 illustrates a plot that collects the previously shown curves of FIGS. 8-11 into a single plot to illustrate the differences in the responses at various stages of various implementations of the disclosed techniques, according to various embodiments;

FIG. 13 illustrates a plot showing an estimated transfer function H_{P}_{_{DRP}}_{/P}_{_{EXT}}(ω) from the external ear point to the drum reference point together with the estimated transfer function H_{P}_{_{DRP}}_{/P}_{_{EP}}(ω) from the ear tip to the drum reference point with the actual measured one in the ear simulator, according to various embodiments;

FIG. 14 is a flow diagram of method steps for determining a microphone acoustic response of an audio system, according to various embodiments; and

FIG. 15 is a flow diagram of method steps for determining ear canal response correction, according to various embodiments.

### DETAILED DESCRIPTION

In the following description, numerous specific details are set forth to provide a more thorough understanding of the various embodiments. However, it will be apparent to one skilled in the art that the inventive concepts can be practiced without one or more of these specific details. For explanatory purposes, multiple instances of like objects are symbolized with reference numbers identifying the object and parenthetical numbers identifying the instance where needed.

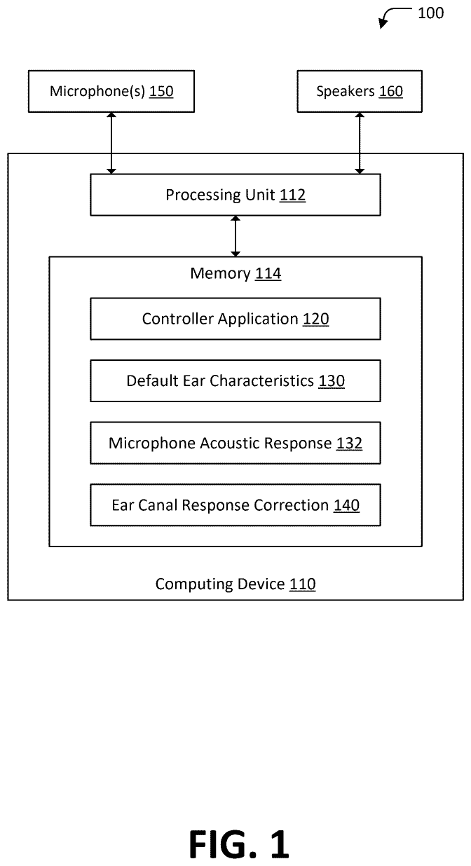

FIG. 1 is a schematic diagram illustrating an audio system 100 according to various embodiments. As shown, the audio system 100 includes, without limitation, a computing device 110, one or more microphones 150, and one or more speakers 160. The computing device 110 includes, without limitation, a processing unit 112 and memory 114. The memory 114 stores, without limitation, a controller application 120, and one or more default ear characteristics 130, microphone acoustic response 132, and an ear canal response correction 140. In some embodiments, audio system 100 represents an earbud, headphone, or other wearable device. The computing device 110 can be attached to, or included in, an earbud or headphone that is calibrated during production.

In operation, the audio system 100 uses various techniques for modeling an ear canal of a user when an earbud or headphone is interfacing with an ear of the user. In this manner, the controller application 120 measures pressures and/or impedance associated with the ear canal and generates the ear canal response correction 140 to compensate for the one or more default ear characteristics 130 when processing audio data.

The computing device 110 generally performs calibration of an earbud, detects default ear characteristics 130, and generates ear canal response correction 140. Computing device 110 also applies ear canal response correction 140 to audio that is output by the one or more speakers 160 of the audio system 100. In some instances, the computing device 110 that performs calibration of the earbud and/or that generates ear canal response correction 140 can be a device that is separate from the earbuds, such as a mobile device to which the earbuds are paired. The processing unit 112 can include one or more central processing units (CPUs), digital signal processing units (DSPs), microprocessors, application-specific integrated circuits (ASICs), neural processing units (NPUs), graphics processing units (GPUs), field-programmable gate arrays (FPGAs), and so forth. The processor(s) 112 generally includes a programmable processor that executes program instructions to manipulate input data and generate outputs. In some embodiments, the processing unit 112 can include any number of processing cores, and other modules for facilitating program execution.

Memory 114 can include a random-access memory (RAM) module, a flash memory unit, or any other type of memory unit or combination thereof. The processing unit 112 is configured to read data from and write data to the memory 114. In various embodiments, the memory 114 includes non-volatile memory, such as optical drives, magnetic drives, flash drives, or other storage. In some embodiments, separate data stores, such as an external data stores included in a network (“cloud storage”) can supplement the memory 114. In various embodiments, an interconnect bus (not shown) connects the processing unit 112, the memory 114, the speaker(s) 160, the microphone(s) 150, and any other components of the computing device 110. Memory includes, without limitation, controller application 120, default ear characteristics 130, and ear canal response correction 140. The controller application 120 within the memory 114 can be executed by the processing unit 112 to implement the overall functionality of the computing device 110 and, thus, to coordinate the operation of the audio system 100 as a whole.

Default ear characteristics 130 include a preconfigured or default pressure response of a user's ear. Default ear characteristics 130 can be asynchronously calculated without any inputs from one or more microphones 150 and loaded into memory 114. For example, a user may choose not to customize the sound reproduction characteristics of audio system 100 by generating ear canal response correction 140. Accordingly, default ear characteristics 130 represent a default behavior of how controller application 120 generates an output signal that is provided to one or more speakers 160 to reproduce sound depending upon the audio features selected by the user, such as ANC, transparency modes, or other audio adjustment or augmentation settings provided by controller application 120.

Controller application 120 performs calibration of the audio system 100 during production or during a calibration process. Calibration of the audio system 100 is performed to calculate an acoustic response of a microphone associated with audio system 100, where the microphone is located inside a calibration tube when inserted therein or inside the ear canal of the user when the audio system 100 is worn by the user. The calibration measures the electrical quantities at driver terminals of the earbuds and measures the pressure detected at the microphone and the pressure detected at another microphone (e.g., a microphone located at a known cavity of a calibration tube). The relationships between the electrical quantities can be represented as transmission matrices. The relationships characterize a response of the one or more microphones 150. The calculated acoustic response of the microphone of the audio system 100 is saved into memory 114 as microphone acoustic response 132 for use during generation of ear canal response correction 140 for a user.

When a listener subsequently uses the earbud, the controller application 120 calculates an acoustic impedance of the eardrum of the user by driving the one or more speakers 160 to reproduce a stimulus signal. Based on the acoustic impedance of the eardrum, controller application 120 determines ear canal response correction 140, which modifies the signal played back by controller application 120 using one or more speakers 160 of the audio system 100. The stimulus signal represents a test signal that is played back by the one or more speakers 160. The stimulus signal could be a log swept sine chirp utilized in acoustic system response measurements. In some embodiments, the stimulus signal includes any signal chosen by the user, such as music or other content that provides sufficient spectral coverage across the audible frequency range. In some embodiments, spectral coverage is accumulated over time opportunistically as spectral coverage evolves.

The controller application 120 predicts the frequency response of the pressure of the ear drum relative to the stimulus signal and determines a first transfer function associated with a measured frequency response. The controller uses the first transfer function to derive the ear canal response correction 140. In some embodiments, the ear canal response correction 140 is a ratio of pressure measured at the ear of the user relative to a default pressure included in the default ear characteristics 130. Additionally or alternatively, the controller application 120 computes a second transfer function between sound pressure measured at a location of the ear canal output and pressure at the ear tip. The controller application 120 determines a third transfer function based on the first transfer function and the second transfer function, where the third transfer function represents the pressure measured at the ear canal output relative to the ear drum of the user. In such instances, the ear canal response correction 140 is a ratio of the third transfer function relative to a default pressure response at the ear drum, as included in the default ear characteristics 130. In some embodiments, the ear canal response correction 140 is used for ANC or other features of the audio system 100 and is a ratio of the pressure measured at the ear drum of the user relative to a default pressure at the ear drum, as included in the default ear characteristics 130.

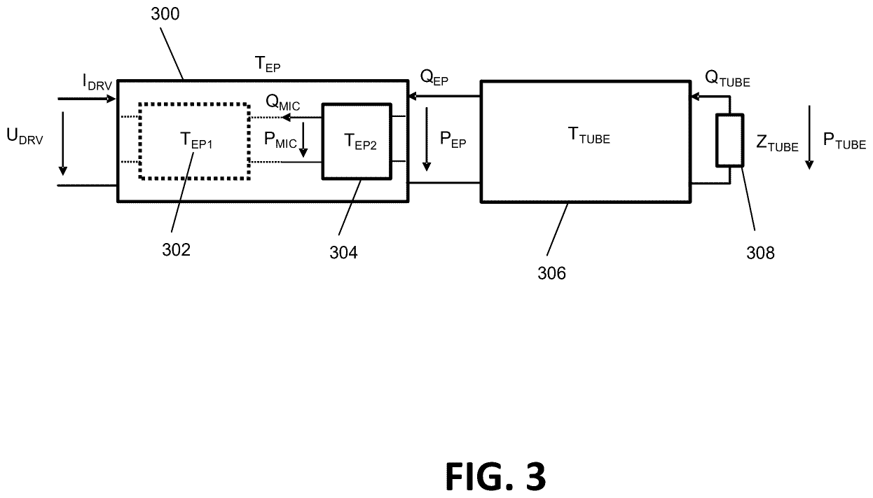

In general, controller application 120 performs calibration of the audio system 100 by determining the properties of the one or more microphones 150 integrated within the audio system 100. Microphone acoustic response 132 of the one or more microphones 150 is determined during production or during a calibration process and stored in memory 114. Controller application 120 characterizes the response of a user's eardrum based on the microphone acoustic response 132 retrieved from memory 114 and sound signals captured by the one or more microphones 150 when the audio system 100 is worn by the user and a test signal is emitted by the one or more speakers 160. Controller application 120 determines one or more relationships between a voltage applied at driver terminals of the one or more speakers 160 and pressures detected at the one or more microphones 150 and, for example, ear tip locations of an earbud. A user's individual ear properties are also measured by controller application 120, which can be performed upon every insertion of the earbud, continuously, or on a periodic schedule, such as a few times per minute. The measurement results associated with the user's ear properties are used to calculate or predict the pressure response at the user's ear drum relative to signals U_{DRV} applied to the one or more speakers 160. In the context of this disclosure, U_{DRV} represents a voltage applied to the input terminals of one or more speakers 160 of audio system 100. From the measurement results associated with the user's ear properties, a calculated pressure at the user's ear drum, P_{DRP}, is determined. P_{DRP} is used to generate ear canal response correction 140. Controller application 120 uses the ear canal response correction 140 to apply corrections to an audio signal that is played back by audio system 100. Controller application 120 can apply additional corrections to an audio signal based on the mode of use of an earbud, such as whether an ANC mode, passthrough mode, transparency mode, or other mode of operation for the earbud is selected by the user. The techniques used by controller application 120 are described in further detail with respect to FIGS. 3-15.

One or more microphones 150 includes, without limitation, any technically feasible microphone that converts sound captured by a diaphragm into electrical signals. The one or more microphones 150 convert air pressure variations of a sound wave into an electrical signal. An earbud can be equipped with multiple microphones. For example, an exterior microphone detects sound occurring outside of the ear canal of the user when the earbud is inserted into the ear canal. An internal microphone, which can also be referred to as an error microphone, detects sound occurring within the ear canal of the user. Accordingly, the one or more microphones 150 can be disposed within the ear canal of the user when the audio system 100 is worn by the user. The one or more microphones 150 are utilized to provide various modes of operation, such as ANC, transparency, or pass-through modes for the user of the earbud.

One or more speakers 160 includes, without limitation, any technically feasible speaker that converts electrical signals into sound. In many embodiments, an earbud includes a single speaker that is disposed within the ear canal of a user when worn by the user.

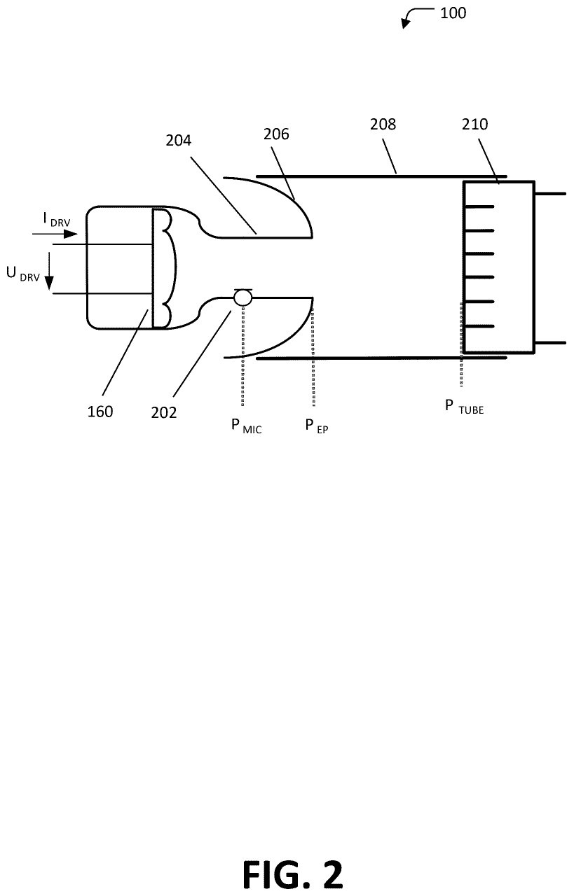

FIG. 2 illustrates an example of an audio system 100, represented as an earbud, according to various embodiments. As shown, audio system 100 includes, without limitation, microphone 202, nozzle 204, and ear tip 206. Calibration tube 208 includes, without limitation, a calibration microphone 210. The audio system 100 is inserted into a calibration tube 208, which is used to perform calibration of audio system 100 during production or during a calibration process. The controller application 120 (not shown) performs calibration of the audio system 100 in one or more calibration tubes 208 of known dimensions.

Calibration tube 208 includes a calibration microphone 210 at a distal end of the calibration tube 208 relative to an insertion point of audio system 100. Calibration tube 208 is a cylindrical or other structure into which audio system 100 fits snugly. The audio system 100 includes, without limitation, a microphone 202, ear tip 206 fitting over the end of the nozzle 204. Voltage U_{DRV} and current I_{DRV} represents a respective voltage and current that are applied to the one or more speakers 160. Calibration tube 208 is used to calibrate the audio system 100 during manufacture. Sound pressure at various positions associated with audio system 100 are also depicted, including P_{MIC}, which indicates sound pressure at the location of microphone 202. Additionally, P_{EP} represents sound pressure at the tip of the audio system 100 that is inserted into calibration tube 208. P_{TUBE} represents sound pressure at the location of microphone 210 at a distal end of the calibration tube 208 relative to the earbud.

FIG. 3 illustrates a representation of a two-port network 300 implemented by controller application 120 that characterizes the behavior of the audio system 100 according to various embodiments. As shown, two-port network 300 includes, without limitation, T_{EP1} 302 and T_{EP2} 304. Using the two-port network 300, controller application 120 determines a microphone acoustic response 132 of the audio system 100. In other words, controller application 120 determines a calculated acoustic response of the one or more microphones 150 based on an acoustic impedance of the calibration tube 208 in which the audio system 100 is inserted. In one example, controller application 120 performs measurements of the behavior of an earbud that are recorded in at least two calibration tubes of different lengths. The responses P_{MIC}(ω) of microphone 202 and P_{TUBE}(ω) of microphone 210 are recorded in at least two calibration tubes of different lengths. Two-port network 300, also referred to as T_{EP} 300, receives voltage U_{DRV}(ω) and current I_{DRV}(ω) applied to one or more speakers 160 as inputs. Two-port network 300 outputs pressure P_{EP}(ω) and volume velocity Q_{EP}(ω) at ear tip. This two-port network T_{EP} 300 can be understood as divisible into a first two-port network T_{EP1} 302 whose inputs are the voltage U_{DRV}(ω) and current I_{DRV}(ω) and outputs are the pressure P_{MIC}(ω) and volume velocity Q_{MIC}(ω) at location of microphone 202; and a second two-port network T_{EP2} 304, whose inputs are the pressure P_{MIC}(ω) and volume velocity Q_{MIC}(ω) at location of microphone 202 and whose outputs are the pressure P_{EP}(ω) and volume velocity Q_{EP}(ω) at the ear tip. The two-port networks T_{EP} 300 and T_{EP2} 304 are given as matrices with elements aᵢⱼ(ω) and dᵢⱼ(ω), respectively, as follows:

$$( \begin{matrix}{U}_{DRV} ( ω ) \\ {I}_{DRV} ( ω )\end{matrix} ) = ( \begin{matrix}{a}_{11} ( ω ) & {a}_{12} ( ω ) \\ {a}_{21} ( ω ) & {a}_{22} ( ω )\end{matrix} ) ( \begin{matrix}{P}_{E P} ( ω ) \\ - {Q}_{E P} ( ω )\end{matrix} ) \qquad Equation 1$$

$$( \begin{matrix}{P}_{MIC} ( ω ) \\ - {Q}_{MIC} ( ω )\end{matrix} ) = ( \begin{matrix}{d}_{11} ( ω ) & {d}_{12} ( ω ) \\ {d}_{21} ( ω ) & {d}_{22} ( ω )\end{matrix} ) ( \begin{matrix}{P}_{EP} ( ω ) \\ - {Q}_{EP} ( ω )\end{matrix} ) \qquad Equation 2$$

In various implementations, the calibration tube 208 is represented by a two-port network 306 that is also designated as T_{TUBE} 306 in FIG. 3. The inputs to two-port network 306 include the pressure P_{EP}(ω) and volume velocity Q_{EP}(ω) at the ear tip 206 of audio system 100 and the outputs are the pressure P_{TUBE}(ω) and volume velocity Q_{TUBE}(ω) at calibration microphone 210 of audio system 100. Complex frequency-dependent matrix elements are represented as bᵢⱼ(ω) in equation 3 below. Calibration microphone 210 is represented by an acoustic impedance Z_{TUBE}(ω) 308. Because Z_{TUBE}(ω)=P_{TUBE}(ω)/−Q_{TUBE}(ω), Equation 3 characterizes two-port network 306:

$$( \begin{matrix}{P}_{EP} ( ω ) \\ - {Q}_{EP} ( ω )\end{matrix} ) = ( \begin{matrix}{b}_{11} ( ω ) & {b}_{12} ( ω ) \\ {b}_{21} ( ω ) & {b}_{22} ( ω )\end{matrix} ) ( \begin{matrix}{P}_{TUBE} ( ω ) \\ - {Q}_{TUBE} ( ω )\end{matrix} ) = ( \begin{matrix}{b}_{11} ( ω ) & {b}_{12} ( ω ) \\ {b}_{21} ( ω ) & {b}_{22} ( ω )\end{matrix} ) ( \begin{matrix}{P}_{TUBE} ( ω ) \\ {P}_{TUBE} ( ω ) / {Z}_{TUBE} ( ω )\end{matrix} ) \qquad Equation 3$$

The calibration tube 208 can be modeled as a transmission line as set forth in Equation 4:

$${T}_{TUBE} = ( \begin{matrix}{b}_{11} ( ω ) & {b}_{12} ( ω ) \\ {b}_{21} ( ω ) & {b}_{22} ( ω )\end{matrix} ) = ( \begin{matrix}cosh ( Γ l ) & {Z}_{0} sinh ( Γ l ) \\ \frac{1}{{Z}_{0}} sinh ( Γ l ) & cosh ( Γ l )\end{matrix} ) \qquad Equation 4$$

In Equation 4, l is the length of the calibration tubes, Γ is a propagation constant, and Z₀ is the characteristic impedance in the tube, the values of which depend on the dimensions of the calibration tubes 208. A cross-sectional discontinuity between the inner diameter of the ear tip output and inner diameter of the tube, or a radiation impedance, can also be accounted for by representing it with a two-port network T_{DISC}, yielding the multiplication of both two-port networks T_{DISC}T_{TUBE} instead of T_{TUBE}. The impedance Z_{TUBE}(ω) at the end of the calibration tube corresponds to the acoustic impedance of the calibration microphone 210 when the parameters are known. In some implementations, the Z_{TUBE}(ω) can be represented by an infinite value.

Using Equations 1 and 3, Equation 5 provides:

$${a}_{11} ( ω ) ( {b}_{11} ( ω ) + \frac{{b}_{12} ( ω )}{{Z}_{TUBE} ( ω )} ) + {a}_{12} ( ω ) ( {b}_{21} ( ω ) + \frac{{b}_{22} ( ω )}{{Z}_{TUBE} ( ω )} ) = \frac{1}{{H}_{{P}_{TUBE} / {U}_{DRV}} ( ω )} \qquad Equation 5$$

In Equation 5, H_{P}_{_{TUBE}}_{/U}_{_{DRV}}(ω) is the measured frequency response of P_{TUBE}(ω) with drive voltage U_{DRV}(ω). Measuring P_{TUBE}(ω) in N calibration tubes (at least 2), the matrix elements a₁₁(ω) and a₁₂(ω) of T_{EP} 300 are then estimated using the Moore Penrose pseudoinverse:

$$( \begin{matrix}{a}_{11} ( ω ) \\ {a}_{12} ( ω )\end{matrix} ) = {( {T}_{m}^{*} {T}_{m} )}^{- 1} {T}_{m}^{*} ( \begin{matrix}\frac{1}{{H}_{{P}_{TUBE} / {U}_{DRV} , 1} ( ω )} \\ ⋮ \\ \frac{1}{{H}_{{P}_{TUBE} / {U}_{DRV} , 1} ( ω )}\end{matrix} ) \qquad Equation 6$$

$$where :$$

$${T}_{m} = ( \begin{matrix}{b}_{11 , 1} ( ω ) + \frac{{b}_{12 , 1} ( ω )}{{Z}_{TUBE} ( ω )} & {b}_{21 , 1} ( ω ) + \frac{{b}_{22 , 1} ( ω )}{{Z}_{TUBE} ( ω )} \\ ⋮ & ⋮ \\ {b}_{11 , N} ( ω ) + \frac{{b}_{12 , N} ( ω )}{{Z}_{TUBE} ( ω )} & {b}_{21 , N} ( ω ) + \frac{{b}_{22 , N} ( ω )}{{Z}_{TUBE} ( ω )}\end{matrix} ) \qquad Equation 7$$

Tₘ^{*} is its conjugate transpose.

Similarly, Equations 2 and 3 are used to arrive at the matrix elements d₁₁(107 ) and d₁₂(ω) of T_{EP2} 304:

$${d}_{11} ( ω ) ( {b}_{11} ( ω ) + \frac{{b}_{12} ( ω )}{{Z}_{TUBE} ( ω )} ) + {d}_{12} ( ω ) ( {b}_{21} ( ω ) + \frac{{b}_{22} ( ω )}{{Z}_{TUBE} ( ω )} ) = \frac{1}{{H}_{{P}_{TUBE} / {U}_{DRV}} ( ω )} \qquad Equation 8$$

$$and$$

$$( \begin{matrix}{d}_{11} ( ω ) \\ {d}_{12} ( ω )\end{matrix} ) = {( {T}_{m}^{*} {T}_{m} )}^{- 1} {T}_{m}^{*} ( \begin{matrix}\frac{1}{{H}_{{P}_{TUBE} / {P}_{MIC} , 1} ( ω )} \\ ⋮ \\ \frac{1}{{H}_{{P}_{TUBE} / {P}_{MIC} , N} ( ω )}\end{matrix} ) \qquad Equation 9$$

The calibrated values of T_{EP} 300 and T_{EP2} 304 are useful in measurements of users' ears to ultimately determine calculated acoustic pressure at the ear drum.

In some implementations, the relationships between voltage U_{DRV}(ω) at driver terminals, pressure P_{MIC}(ω) and pressure P_{DRP}(ω) of mass-produced earbuds can be characterized by sampling a subset of production units, and by tight control during manufacturing. Alternately, in other implementations, the output of every individual earbud can be characterized at the end of a production line and stored in memory 114 in each audio system 100 and accessible to controller application 120.

Once controller application 120 determines a response that characterizes the microphone 202 during the calibration process, the controller application 120 then obtains measurements characterizing the ear of a user using the one or more microphone(s) 150. The measurements are made in response to a stimulus signal that is played back by one or more speakers 160. The response to the stimulus signal is captured by one or more microphones 150. Controller application 120 measures the sound pressure P_{MIC}(ω) upon placement of the earbud into the ear of the user. A response H_{P}_{_{MIC}}_{/U}_{_{DRV}}(ω) is measured using the one or more microphone(s) 150. Controller application 120 further calculates the impedance Z_{EC}(ω) 406 of the ear canal based upon the sound pressure. Additionally, the response at the ear tip location of the earbud, H_{P}_{_{EP}}_{/U}_{_{DRV}}(ω), is calculated.

Finally, controller application 120 measures and calculates the user's ear response controller application 120 based on input from the microphone(s) 150. Controller application 120 plays a stimulus signal U_{DRV} using one or more speakers 160 of audio system 100, or the earbud, and the signal P_{MIC}(ω) is recorded. In one embodiment, the stimulus signal is a log swept sine chirp to use in acoustic system response measurements. In other examples, the signal is any signal chosen by the user, for example music or other content, that provides sufficient spectral coverage. Spectral coverage can be accumulated over time opportunistically as spectral coverage evolves during playback of the test signal. The result of this measurement is a frequency response H_{P}_{_{MIC}}_{/U}_{_{DRV}}(ω) that is used to arrive at the frequency response H_{P}_{_{EP}}_{/U}_{_{DRV}}(ω).

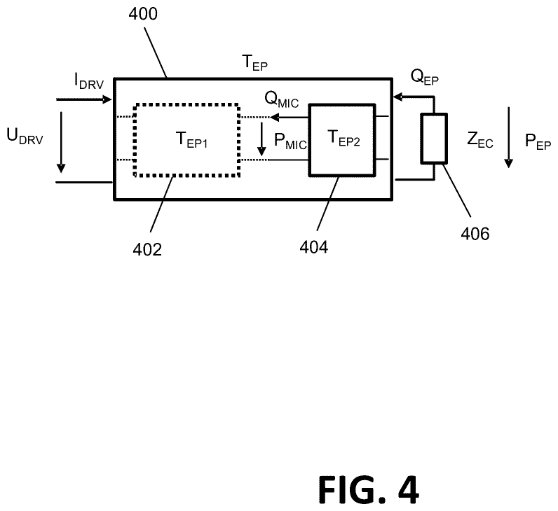

FIG. 4 illustrates the two two-port networks T_{EP} 400 and T_{EP2} 404 implemented by controller application 120 shown with an unknown acoustic load Z_{EC}(ω) 406 that represents the ear canal according to various embodiments. A user's ear canal places an acoustic load on the audio system 100 when the device is worn by the user, so controller application 120 determines the acoustic impedance of the user's ear or ear canal. Each of the two-port networks has a relationship between H_{P}_{_{EP}}_{/U}_{_{DRV}}(ω) and Z_{EC}(ω) 406, allowing to solve for H_{P}_{_{EP}}_{/U}_{_{DRV}}(ω).

Using Equations 1 and 2 above, the measured frequency response H_{P}_{_{MIC}}_{/U}_{_{DRV}}(ω), and recognizing that Z_{EC}(ω)=P_{EC}(ω)/−Q_{EP}(ω), the frequency responses are shown in equations 10 and 11 below:

$${H}_{{P}_{EP} / {U}_{DRV}} ( ω ) = \frac{1}{{a}_{11} ( ω ) + \frac{{a}_{12} ( ω )}{{Z}_{EC} ( ω )}} \qquad Equation 10$$

$${H}_{{P}_{EP} / {U}_{DRV}} ( ω ) = {H}_{{P}_{MIC} / {U}_{DRV}} ( ω ) \frac{1}{{d}_{11} ( ω ) + \frac{{d}_{12} ( ω )}{{Z}_{EC} ( ω )}} \qquad Equation 11$$

Equations 10 and 11 can be used to solve for _{ZEC}(ω):

$${Z}_{EC} ( ω ) = \frac{{H}_{{P}_{MIC} / {U}_{DRV}} ( ω ) {a}_{12} ( ω ) - {d}_{12} ( ω )}{{d}_{11} ( ω ) - {H}_{{P}_{MIC} / {U}_{DRV}} ( ω ) {a}_{11} ( ω )} \qquad Equation 12$$

Substituting Equation 12 back into Equation 10, the frequency response H_{P}_{_{EP}}_{/U}_{_{DRV}}(ω) is:

$${H}_{{P}_{EP} / {U}_{DRV}} ( ω ) = \frac{{H}_{{P}_{MIC} / {U}_{DRV}} ( ω ) {a}_{12} ( ω ) - {d}_{12} ( ω )}{{a}_{12} ( ω ) {d}_{11} ( ω ) - {a}_{11} ( ω ) {d}_{12} ( ω )} \qquad Equation 13$$

Equation 13 provides the response at the ear tip 206 based on a measurement of the one or more microphones 150 and on the previous characterization of the earbud while the earbud is being loaded by the impedance of a particular ear.

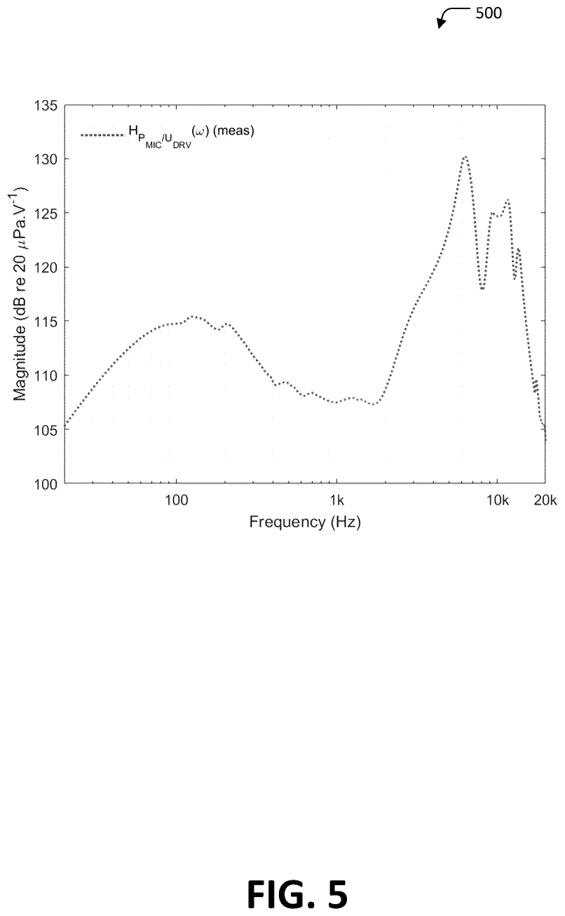

FIG. 5 illustrates an example measurement of the one or more microphones 150 performed by controller application 120 according to various embodiments. As shown in FIG. 5, plot 500 illustrates the magnitude of H_{P}_{_{MIC}}_{/U}_{_{DRV}}(ω) vs. frequency. Such a measurement can be recorded in an ear simulator that simulates the average human ear response per international specification ITU-T P.57 06/2021.

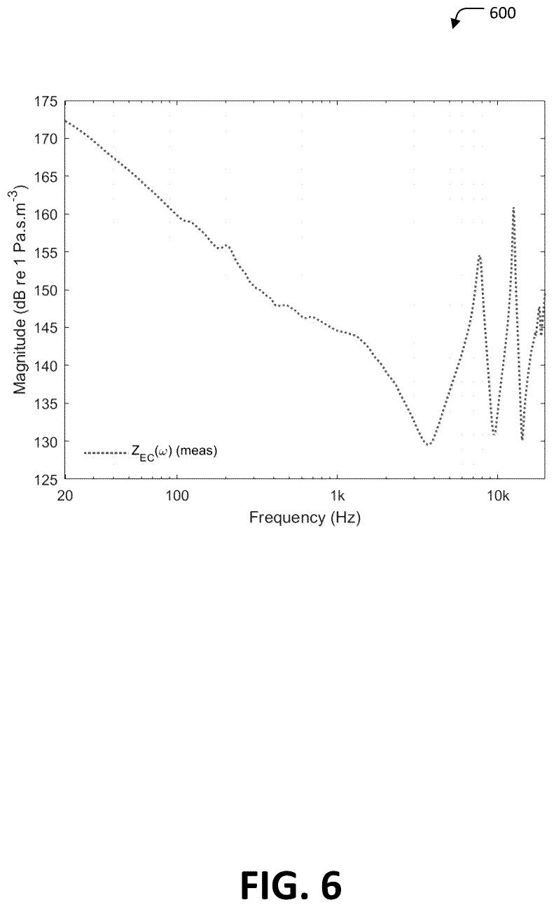

FIG. 6 illustrates an example of a plot 600 showing a calculation of Z_{EC}(ω) 406 at the ear tip 206 of an audio system 100 according to various embodiments. In one example, the data captured by controller application 120 and that is illustrated in FIG. 5 is used in Equation 12, along with the matrix elements aᵢⱼ(ω) and dᵢⱼ(ω) of the two-port networks TEP 400 and T_{EP2} 404, respectively, to calculate the ear input impedance Z_{EC}(ω) 406 at the ear tip location.

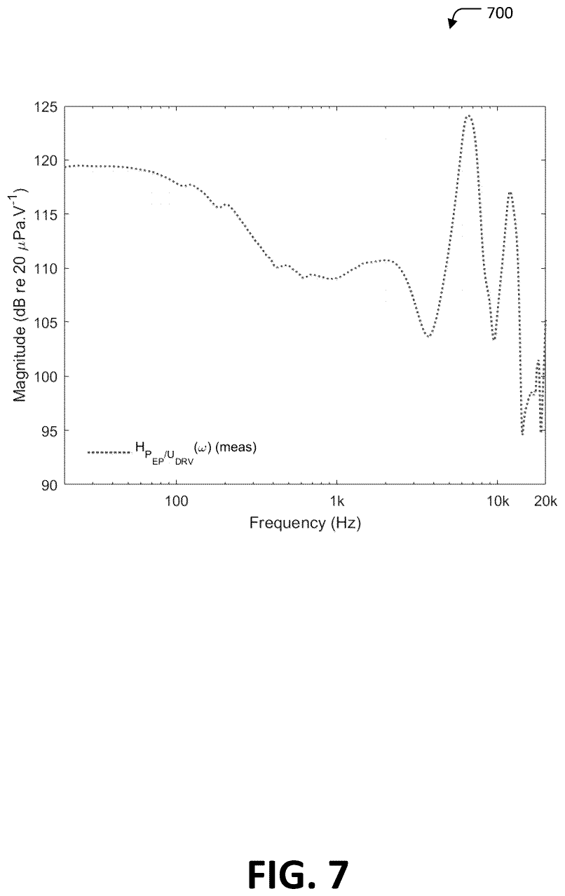

FIG. 7 illustrates an example of a plot 700 showing the calculation P_{EP}(ω) at the ear tip 206 of an audio system 100 according to various embodiments. In some implementations, the microphone measurement H_{P}_{_{MIC}}_{/U}_{_{DRV}}(ω) could be used directly in Equation 13 or together with Z_{EC}(ω) 406 in Equations 10 or 12, to yield H_{P}_{_{EP}}_{/U}_{_{DRV}}(ω). The response illustrated in plot 700 is the response at the ear tip 206 when the audio system 100 is acoustically loaded by the ear canal and eardrum of a user. The response is used to arrive at the response at the eardrum reference point of the user.

In some alternative embodiments, ear impedance of a user can also be calculated by controller application 120 based on the current flowing to the one or more speakers 160 of audio system 100 rather than using measurements from one or more microphones 150. For example, responses to I_{DRV}(ω) and P_{TUBE}(ω) by the one or more microphones 150 of audio system 100 are recorded in at least two calibration tubes of different lengths. A two-port network that fully characterizes the earbud behavior is calculated from the calibration tube measurements as described above.

The current I_{DRV}(ω) can be measured through the measured voltage at the terminals of a known resistive load in series with one or more speakers 160 for instance. The matrix elements a₁₁(ω) and a₁₂(ω) of TEP 300 are estimated using Equations 6 and 7. Additionally, the matrix elements a₂₁(ω) and a₂₂(107 ) of T_{EP} 300 can be expressed using Equations 1 and 3 as shown in Equation 14:

$${a}_{21} ( ω ) ( {b}_{11} ( ω ) + \frac{{b}_{12} ( ω )}{{Z}_{TUBE} ( ω )} ) + {a}_{22} ( ω ) ( {b}_{21} ( ω ) + \frac{{b}_{22} ( ω )}{{Z}_{TUBE} ( ω )} ) = \frac{1}{{TZ}_{{P}_{TUBE} / {I}_{D R V}} ( ω )} \qquad Equation 14$$

In Equation 14, TZ_{P}_{_{TUBE}}_{/I}_{_{DRV}}(ω) is the measured transfer impedance of P_{TUBE}(ω) with current I_{DRV}(ω). Measuring P_{TUBE}(ω) in N calibration tubes (at least 2), the matrix elements a₂₁(ω) and a₂₂(ω) of T_{EP} 300 are estimated using Equation 15 below.

$$( \begin{matrix}{a}_{21} ( ω ) \\ {a}_{22} ( ω )\end{matrix} ) = {( {T}_{m}^{*} {T}_{m} )}^{- 1} {T}_{m}^{*} ( \begin{matrix}\frac{1}{{TZ}_{{P}_{TUBE} / {I}_{DRV} , 1} ( ω )} \\ ⋮ \\ \frac{1}{{TZ}_{{P}_{TUBE} / {I}_{MIC} , N} ( ω )}\end{matrix} ) \qquad Equation 15$$

In Equation 15, Tₘ is derived in Equation 7. Next, impedance Z_{DRV}(ω) is measured. Based on Z_{DRV}(ω), impedance Z_{EC}(ω) 406 of the ear canal is calculated. Finally, a response at the ear tip 206 location H_{P}_{_{EP}}_{/U}_{_{DRV}}(ω) is calculated.

To facilitate the measurement of the current I_{DRV}(ω), a stimulus signal U_{DRV}(ω) is played using the one or more speakers 160 of the audio system 100, and the signal I_{DRV}(ω) is recorded. The result of this measurement is the response Z_{DRV}(ω)=U_{DRV}(ω)/I_{DRV}(ω), which is subsequently used to arrive at the frequency response H_{P}_{_{EP}}_{/U}_{_{DRV}}(ω). The response Z_{DRV}(ω) corresponds to the electrical impedance of the driver loaded at the back by acoustic elements of the audio system 100, and at the front by other acoustic elements of the audio system 100 and by the user's ear.

The user's ear canal places an acoustic load Z_{EC}(ω) 406 on the audio system 100.

$${H}_{{P}_{EP} / {I}_{DRV}} ( ω ) = \frac{1}{{a}_{21} ( ω ) + \frac{{a}_{22} ( ω )}{{Z}_{EC} ( ω )}} \qquad Equation 16$$

Equations 10 and 16 can be solved to calculate Z_{EC}(ω) 406 using Equation 17:

$${Z}_{EC} ( ω ) = \frac{{a}_{12} ( ω ) - {a}_{22} ( ω ) {Z}_{DRV} ( ω )}{{a}_{21} ( ω ) {Z}_{DRV} ( ω ) - {a}_{11} ( ω )} \qquad Equation 17$$

Substituting Equation 17 back into Equation 10, the frequency response H_{P}_{_{EP}}_{/U}_{_{DRV}}(ω) is:

$${H}_{{P}_{EP} / {U}_{DRV}} ( ω ) = \frac{\frac{{a}_{12} ( ω )}{{Z}_{DRV} ( ω )} - {a}_{22} ( ω )}{{a}_{12} ( ω ) {a}_{21} ( ω ) - {a}_{11} ( ω ) {a}_{22} ( ω )} \qquad Equation 18$$

Controller application 120 calculates the response of the ear drum of the user in response to the stimulus signal. The modal parameters of the ear are estimated from the input admittance Y_{EC}(ω). Next, a transfer function H_{P}_{_{DRP}}_{/P}_{_{EP}}(ω) is designed from the modal parameters. Then, the pressure P_{DRP}(ω) at the drum reference point is calculated from the transfer function and the calculated pressure P_{EP}(ω).

Similar to the calibration tube illustrated in FIG. 3, a user's ear canal can be represented by a two-port network T_{EC} whose inputs are the pressure P_{EP}(ω) and volume velocity Q_{EP}(ω) at ear tip, and the outputs are the pressure P_{DRP}(ω) and volume velocity Q_{DRP}(ω) at drum reference point. The complex frequency-dependent matrix elements of T_{EC} are represented as cᵢⱼ(ω) in Equation 19 below. A user's ear drum can be represented by an impedance Z_{DRP}(ω)=P_{DRP}(ω)/−Q_{DRP}(ω), leading to:

$$( \begin{matrix}{P}_{EP} ( ω ) \\ - {Q}_{EP} ( ω )\end{matrix} ) = ( \begin{matrix}{c}_{11} ( ω ) & {c}_{12} ( ω ) \\ {c}_{21} ( ω ) & {c}_{22} ( ω )\end{matrix} ) ( \begin{matrix}{P}_{DRP} ( ω ) \\ - {Q}_{DRP} ( ω )\end{matrix} ) = ( \begin{matrix}{c}_{11} ( ω ) & {c}_{12} ( ω ) \\ {c}_{21} ( ω ) & {c}_{22} ( ω )\end{matrix} ) ( \begin{matrix}{P}_{DRP} ( ω ) \\ {P}_{DRP} ( ω ) / {Z}_{DRP} ( ω )\end{matrix} ) \qquad Equation 19$$

The input impedance Z_{EC}(ω) 406 at the ear tip 206 location can then be expressed as shown in Equation 20.

$${Z}_{EC} ( ω ) = \frac{{P}_{EP} ( ω )}{- {Q}_{EP} ( ω )} = \frac{\frac{{P}_{EP} ( ω )}{{P}_{DRP} ( ω )}}{\frac{- {Q}_{EP} ( ω )}{{P}_{DRP} ( ω )}} = \frac{{c}_{11} ( ω ) + \frac{{c}_{12} ( ω )}{{Z}_{DRP} ( ω )}}{{c}_{21} ( ω ) + \frac{{c}_{22} ( ω )}{{Z}_{DRP} ( ω )}} \qquad Equation 20$$

Using the two-port network representation in Equations 19 and 20 for estimating the frequency response H_{P}_{_{DRP}}_{/P}_{_{EP}}(ω) from the input impedance Z_{EC}(ω) 406 includes identifying the matrix elements cᵢⱼ(ω) of TEC and ear drum impedance Z_{DRP}(ω). In some implementations, because the ear canal geometry and ear drum impedance are unique for every user, this process involves unknown parameters.

Alternatively, the input impedance Z_{EC}(ω) 406 can also be characterized as the ratio of two polynomials whose roots are zeros and poles for the numerator and denominator polynomials respectively. The reciprocal of the numerator polynomial of the input impedance Z_{EC}(ω) 406 corresponds to the ear resonances between pressures at the earbud and ear drum. These resonances are characterized by the eigenfrequencies, which include the natural frequencies and damping ratios. These modal parameters depend on the ear canal geometry and ear drum impedance. Assuming the acoustic quantities being linear, the eigenfrequencies remain the same along the ear canal from the ear tip output up to the ear drum. Additionally, the frequency response between pressures at ear tip and ear drum, which is assumed being the end of the ear canal, does not include any zeros and can thus be retrieved from these eigenfrequencies.

Accordingly, controller application 120 estimates the eigenfrequencies of the ear. In some implementations, the eigenfrequencies are determined from the poles from one or several frequency response measurements. In some implementations, these eigenfrequencies are extracted from the input admittance Y_{EC}(ω) using a rational fractional polynomial method.

In some implementations, the number of resonances is determined by controller application 120 by counting the resonance peaks in the input admittance Y_{EC}(ω). As the ear canal is limited to a certain length, a given number of resonances in the frequency range of interest can be predicted. Alternatively, in some implementations, the number of peaks above a given prominence in the input admittance Y_{EC}(ω) can be identified. The curve fitting can be restricted over a frequency range delimited by the first and last resonances for the input impedance, increased by one octave band on the lower limit and one-third octave band for the upper limit for example. Regarding the number of zeros given as input for the algorithm, it could voluntarily be enhanced to control out-of-bands effects over the resonances of the denominator polynomial as suggested in the art, thus increasing the accuracy of curve fitting.

The denominator polynomial coefficients are fit by minimizing an error function based on the measured input admittance and the analytical model of specified number of poles and zeros within the limited frequency range surrounding the resonance peaks. The eigenfrequencies, which correspond to the roots of this polynomial, and which include modal parameters of natural frequency and damping ratio, are then calculated. A second curve fitting step can be performed, where the numerator polynomial coefficients are estimated, allowing the reconstitution of the input admittance. In some implementations, other modal parameter extraction methods could also be used such as the peak amplitude method, the circle fit method, the least square complex exponential method, or the eigensystem realization algorithm method.

Controller application 120 designs a transfer function based on the modal parameters of the ear canal that are as follows:

$${H}_{{P}_{DRP} / {P}_{EP}} ( ω ) = {G}_{0} {H}_{corr , N} ( ω ) {\sum }_{n = 1}^{N} {H}_{EC , n} ( ω ) = {G}_{0} {H}_{corr , N} ( ω ) {\sum }_{n = 1}^{N} \frac{{( - 1 )}^{n - 1} {ω}_{0 , n} \sqrt{1 - {ζ}_{EC , n}^{2}}}{{ω}_{0 , n}^{2} - {ω}^{2} + 2 j ω {ζ}_{EC , n} {ω}_{0 , n}} \qquad Equation 21$$

In Equation 21, j is the imaginary unit, ω is the angular frequency, ω_{0,n} is the natural frequency, and ζ_{EC,n} is the damping ratio associated with the eigenfrequency n. The gain G₀ is chosen such that |H_{P}_{_{DRP}}_{/P}_{_{EP}}(ω)|_{ω÷0}=1. Finally, an optional correction transfer function H_{corr,N}(ω), which depends on the number of modeled eigenfrequencies N, may be applied to correct the small magnitude error and phase error of modal expansion relative to the closed form, as higher ear canal resonances are not modeled.

An alternative to the modal expansion approach is the use of a deep learning model. Many ear canals can be modeled via parametric-based geometries or humans' ear scans that are terminated by eardrum impedances for instance. These eardrum impedances can be modeled as multi-degree-of-freedom resonators, whose values correspond to actual predictions found in the state of the art. Then, sets of ear impedances Z_{EC}(ω) 406 and ear canal transfer functions H_{P}_{_{EP}}_{/U}_{_{DRV}}(ω) between the ear entrance and eardrum are calculated. Finally, a deep learning model is trained, where the ear impedances Z_{EC}(ω) 406 are the input dataset, and the ear canal transfer functions H_{P}_{_{EP}}_{/U}_{_{DRV}}(ω) are the output dataset. As the ear impedances Z_{EC}(ω) 406 can be measured as described in the previous sections, a corresponding ear canal transfer function H_{P}_{_{DRP}}_{/P}_{_{EP}}(ω) is generated from the deep learning model.

Controller application 120 then determines the pressure at the eardrum P_{DRP}(ω) using Equation 22:

$${P}_{DRP} ( ω ) = {H}_{{P}_{DRP} / {P}_{EP}} ( ω ) {H}_{{P}_{EP} / {U}_{DRV}} ( ω ) {U}_{DRV} ( ω ) \qquad Equation 22$$

In Equation 22 The frequency response H_{P}_{_{EP}}_{/U}_{_{DRV}}(ω) is calculated as set forth above in the discussion of how controller application 120 calculates P_{EP}(ω) response at ear tip 206.

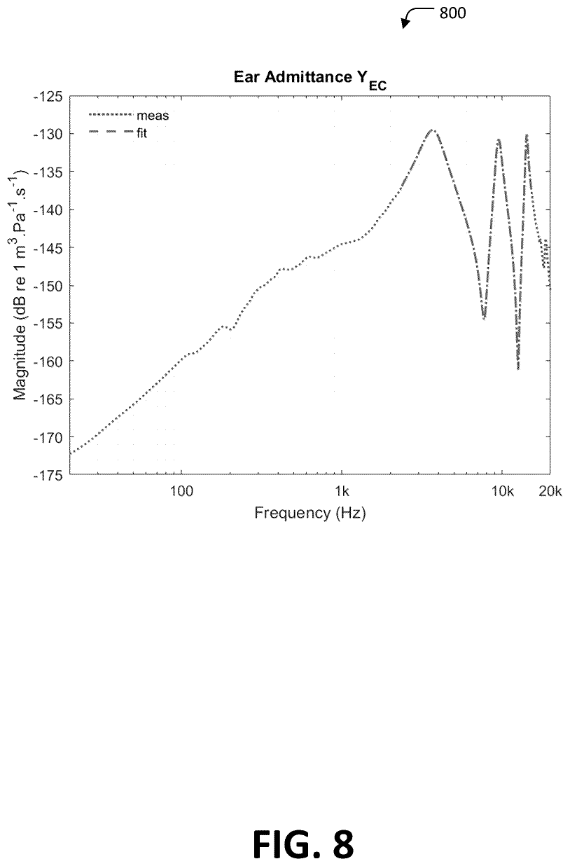

FIGS. 8-12 illustrate how controller application 120 characterizes the ear drum of a user according to various embodiments.

FIG. 8 illustrates a plot 800 showing the ear input admittance Y_{EC}(ω) according to various embodiments. The plot 800 is obtained by taking the reciprocal of the ear input impedance Z_{EC}(ω) 406 of FIG. 6, with a dotted line. The admittance estimated from the rational polynomial fitting procedure within a limited frequency range surrounding the resonances is overlaid with a dashed-dotted line.

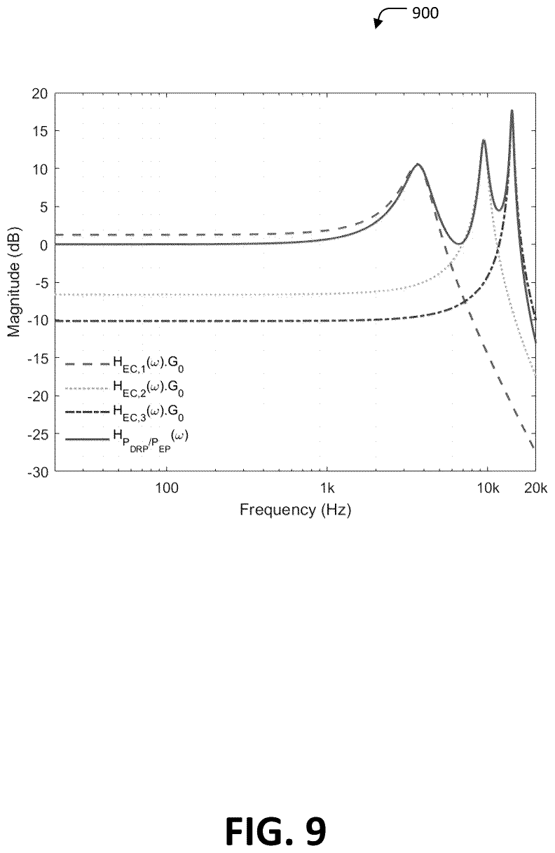

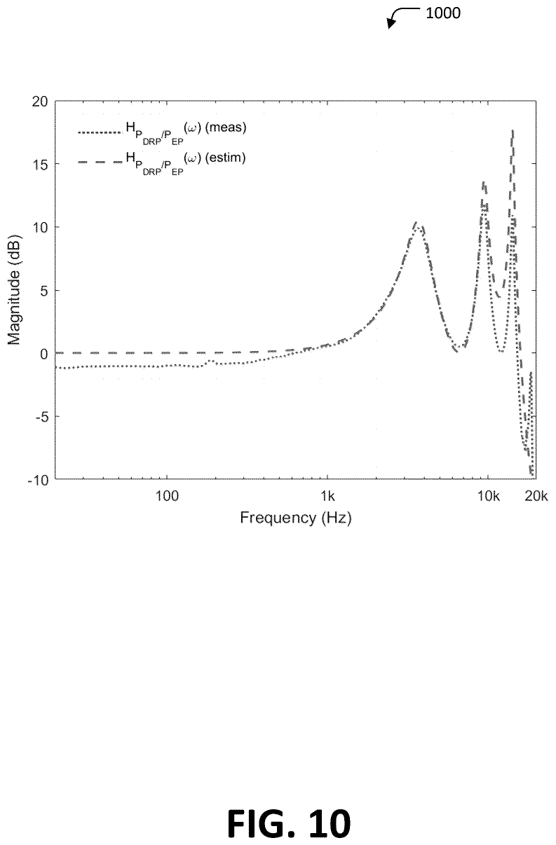

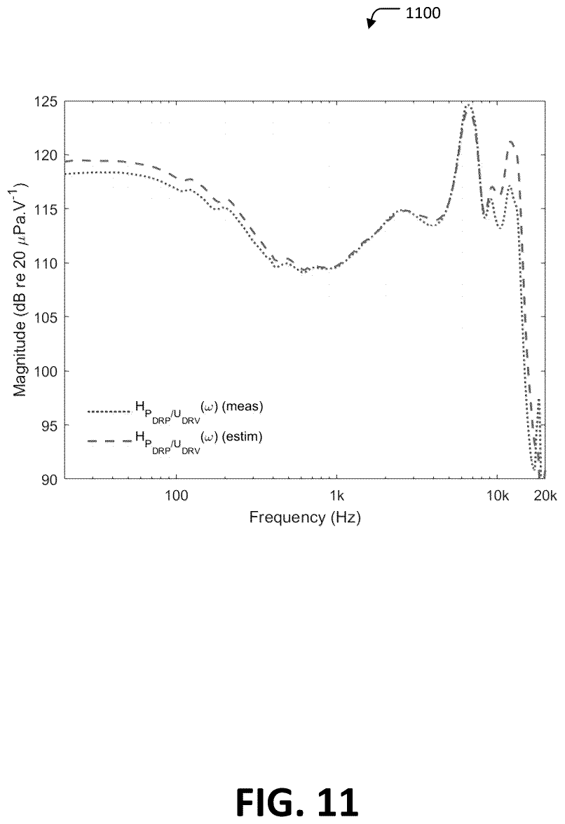

FIG. 9 illustrates a plot 900 that shows the summation of H_{P}_{_{DRP}}_{/P}_{_{EP}}(ω) from individual filters that are built from the modal parameters according to Equation 21. FIG. 10 illustrates plot 1000 showing a comparison of the ear tip to ear drum transfer function shown with a transfer function of the measured pressure P_{DRP}(ω) response at the drum reference point relative to the pressure P_{EP}(ω) response obtained from Equation 13. FIG. 11 illustrates plot 1100 showing a predicted pressure at a drum reference point with the actual measured pressure in the ear simulator.

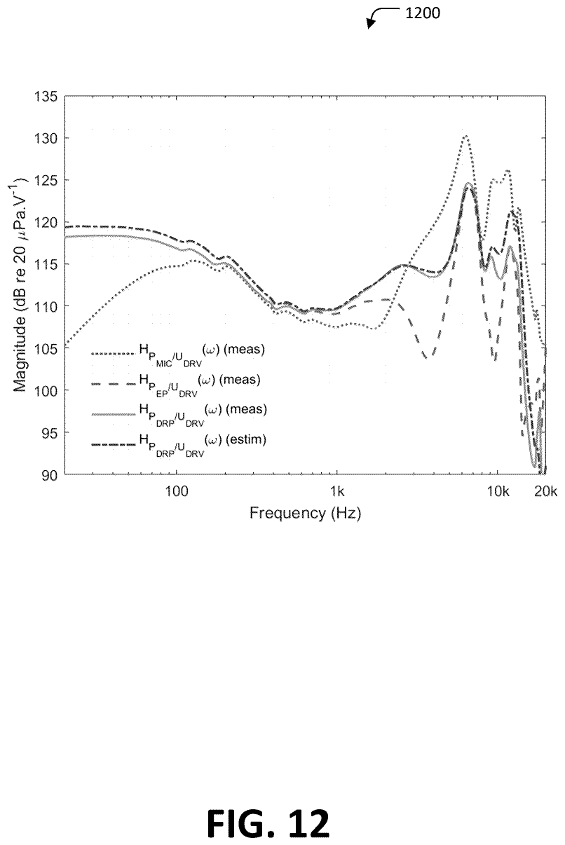

FIG. 12 illustrates a plot 1200 that collects the previously shown curves of FIGS. 8-11 into a single plot 1200 to illustrate the differences in the responses at various stages of various implementations of the disclosed techniques. Plot 1200 further illustrates the significance of the non-trivial transformations that take place at each step. The pressure P_{MIC}(ω) response measured from one or more microphones 150 is illustrated along with pressure at the ear tip. Additionally, the curves of FIG. 11 are also shown, which illustrate the nearly identical measured and estimated pressure P_{DRP}(ω), here shown in solid line and dashed-dotted line respectively.

Controller application 120 also applies correction transfer functions to P_{DRP}(ω). The correction transfer functions, or ear canal response correction 140, are dependent upon a mode of operation selected by the user, such as ANC or hear-through modes.

In one example, controller application 120 performs individualization of target curves. Headphones and earbuds are often designed to have a specific frequency response at the drum reference point, known as a “target curve.” One target curve, identified as pleasing to a high number of listeners, is the Harman Target Curve for in-ear headphones H_{IEHTC}(ω). The Harman target response H_{IEHTC/U}_{_{DRV}}(ω)=H_{IEHTC}(ω)/U_{DRV}(ω) is designed on an ear simulator relative to the voltage U_{DRV}(ω). To enable an individual listener to hear the Harman target response, correction function H_{C}(ω) is applied to the signal before playback, which can be defined as

$${H}_{C} ( ω ) = \frac{{H}_{IEHTC / {U}_{DRV}} ( ω )}{{H}_{{P}_{DRP} / {U}_{DRV}} ( ω )} \qquad Equation 22$$

In Equation 22, H_{P}_{_{DRP}}_{/U}_{_{DRV}}(ω) is the pressure response estimated at the user's eardrum. The correction function can be limited to a given frequency range, such as from 20 Hz to 10 kHz and bypassed above 10 kHz.

In another implementation, an individualized target curve can be designed by controller application 120 based on the estimated pressure response H_{P}_{_{DRP}}_{/U}_{_{DRV}}(ω) at the user's eardrum. First, the amount of fit leakage is estimated from the ear impedance Z_{EC}(ω) and compensated via a transfer function H_{LC}(ω). Then, a transfer function H_{P}_{_{DRP}}_{/P}_{_{EXT}}(ω) from the external ear to the drum reference point is designed. Then, a bass shelf filter H_{BSF}(ω) is calculated. Finally, the correction transfer function H_{C}(ω) is designed.

The fit leakage, which happens when the ear tip 206 is not sealed in the user's ear, can be represented by a shunt impedance Zₗₑₐₖ(ω) which can be modeled by an acoustic cylindrical port or slit with a radiation impedance for instance. First, a two-port network T_{EC3} whose inputs are the pressure P_{EP,LC}(ω) and volume velocity Q_{EP,LC}(ω) and outputs are the pressure P_{EP}(ω) and volume velocity Q_{EP}(ω) at the ear tip 206 represents a model of the leakage compensation. To estimate a sealed ear impedance Z_{EC,LC}(ω)=P_{EP,LC}(ω)/−Q_{EP,LC}(ω) which corresponds to the ear impedance Z_{EC}(ω) 406 with the leakage compensation, the two-port network T_{EC3} then corresponds to the inverse of a two-port network representing the shunt impedance Zₗₑₐₖ(ω) which can be represented in Equation 23.

$$( \begin{matrix}{P}_{EP , LC} ( ω ) \\ - {Q}_{EP , LC} ( ω )\end{matrix} ) = {( \begin{matrix}1 & 0 \\ 1 / {Z}_{leak} ( ω ) & 1\end{matrix} )}^{- 1} ( \begin{matrix}{P}_{EP} ( ω ) \\ - {Q}_{EP} ( ω )\end{matrix} ) \qquad Equation 23$$

The ear impedance Z_{EC,LC}(ω) with leakage compensation at the ear tip is written as follows:

$${Z}_{EC , LC} ( ω ) = \frac{{P}_{EP , LC} ( ω )}{- {Q}_{EP , LC} ( ω )} = \frac{{Z}_{EC} ( ω ) {Z}_{leak} ( ω )}{{Z}_{leak} ( ω ) - {Z}_{EC} ( ω )} \qquad Equation 24$$

The ear impedance Z_{EC,LC}(ω) with leakage compensation can be estimated by minimizing the variance of jωZ_{EC,LC}(ω) over a given low-frequency range, from 20 Hz up to 500 Hz for instance, in function of the parameters of the shunt impedance Zₗₑₐₖ(ω).

Referring back to FIG. 4, the ear impedance Z_{EC}(ω) 406 is replaced by the ear impedance Z_{EC,LC}(ω) with leakage compensation and the pressure response H_{P}_{_{EP,LC}}_{/U}_{_{DRV}}(ω) is calculated using Equation 10 similar to H_{P}_{_{EP}}_{/U}_{_{DRV}}(ω)

$${H}_{{P}_{EP , LC} / {U}_{DRV}} ( ω ) = \frac{1}{{a}_{11} ( ω ) + \frac{{a}_{12} ( ω )}{{Z}_{EC , LC} ( ω )}} \qquad Equation 25$$

Finally, the leakage compensation transfer function H_{LC}(ω) is defined as

$${H}_{LC} ( ω ) = \frac{{H}_{{P}_{EP , LC} / {U}_{DRV}} ( ω )}{{H}_{{P}_{EP} / {U}_{DRV}} ( ω )} \qquad Equation 26$$

Controller application 120 designs a transfer function H_{P}_{_{DRP}}_{/P}_{_{EXT}}(ω) from the external ear point to the drum reference point. This external ear point is a virtual point for geometric reference located close to the ear entrance point of the listener's ear, which can be chosen at the transition between the ear canal and concha. A part of the ear canal from the ear entrance point to the ear tip can be represented by a two-port network T_{EC2} whose inputs are the pressure P_{EEP}(ω) and volume velocity Q_{EEP}(ω) and outputs are the pressure P_{EP}(ω) and volume velocity Q_{EP}(ω) and complex frequency-dependent matrix elements are represented by Cᵢⱼ(ω) as follows

$$( \begin{matrix}{P}_{EEP} ( ω ) \\ - {Q}_{EEP} ( ω )\end{matrix} ) = ( \begin{matrix}{c}_{11} ( ω ) & {c}_{12} ( ω ) \\ {c}_{21} ( ω ) & {c}_{22} ( ω )\end{matrix} ) ( \begin{matrix}{P}_{EP , LC} ( ω ) \\ - {Q}_{EP , LC} ( ω )\end{matrix} ) \qquad Equation 27$$

The geometry of this ear canal portion can be modeled as a cylindrical tube as written in Equation 4 or a truncated cone whose dimensions are predefined. The geometry can also be modeled by dividing it into segments of short lengths represented by several two-port networks in cascade. The radiation impedance Z_{rad}(ω) of the open ear canal at the external ear point is represented by a two-port network T_{EC1}, whose inputs are the pressure P_{EXT}(ω) and volume velocity Q_{EXT}(ω) and outputs are the pressure P_{EEP}(ω) and volume velocity Q_{EEP}(ω) as follows

$$( \begin{matrix}{P}_{EXT} ( ω ) \\ {Q}_{EXT} ( ω )\end{matrix} ) = ( \begin{matrix}1 & {Z}_{rad} ( ω ) \\ 0 & 1\end{matrix} ) ( \begin{matrix}{P}_{EEP} ( ω ) \\ - {Q}_{EEP} ( ω )\end{matrix} ) \qquad Equation 28$$

In Equation 28, the radiation impedance Z_{rad}(ω) depends on the dimensions of the open ear canal defined in the two-port network T_{EC2}. Using Equations 27 and 28 while recalling Z_{EC,LC}(ω)=P_{EP,LC}(ω)/−Q_{EP,LC}(ω), Equation 29 then specifies:

$${H}_{{P}_{EP , LC} / {P}_{EXT}} ( ω ) = \frac{1}{{c}_{11} ( ω ) + {Z}_{rad} ( ω ) {c}_{21} ( ω ) + \frac{{c}_{12} ( ω ) + {Z}_{rad} ( ω ) {c}_{22} ( ω )}{{Z}_{EC , LC} ( ω )}} \qquad Equation 29$$

If the fit leakage is relatively light, it follows that the ear impedance Z_{EC,LC}(ω) with leakage compensation is identical to the ear impedance Z_{EC}(ω) from a frequency below the first eigenfrequency. The transfer function H_{P}_{_{DRP}}_{/P}_{_{EP,LC}}(ω) from the ear tip to the drum reference point with leakage compensation may be considered as being equal to the transfer function H_{P}_{_{DRP}}_{/P}_{_{EP}}(ω) without compensation. Otherwise, the transfer function H_{P}_{_{DRP}}_{/P}_{_{EP,LC}}(ω) is designed from the ear impedance Z_{EC,LC}(ω) with leakage compensation as described above.

Finally, the final open ear transfer function from the external ear point to the drum reference point is estimated as

$${H}_{{P}_{DRP} / {P}_{EXT}} ( ω ) = {H}_{{P}_{DRP} / {P}_{EP , LC}} ( ω ) {H}_{{P}_{EP , LC} / {P}_{EXT}} ( ω ) \qquad Equation 30$$

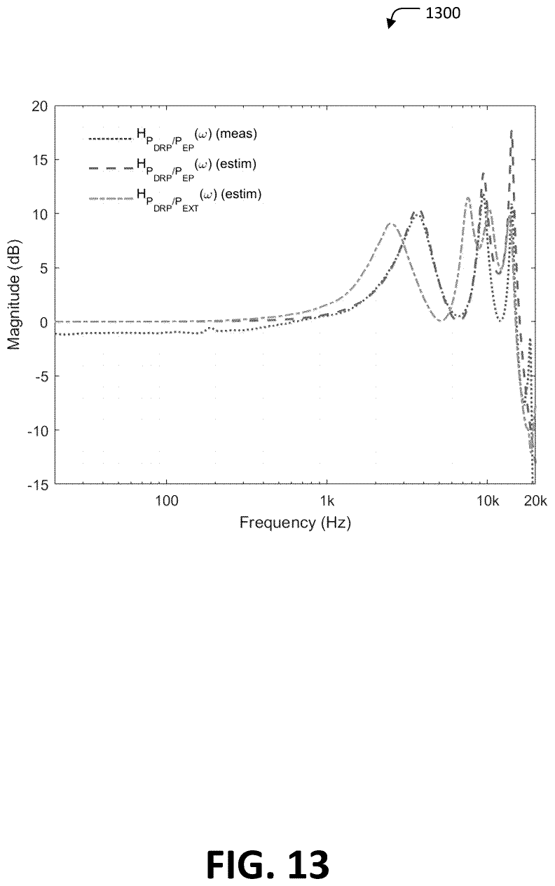

FIG. 13 illustrates a plot 1300 showing an estimated transfer function H_{P}_{_{DRP}}_{/P}_{_{EXT}}(ω) from the external ear point to the drum reference point together with the estimated transfer function H_{P}_{_{DRP}}_{/P}_{_{EP}}(ω) from the ear tip to the drum reference point with the actual measured one in the ear simulator, which are already illustrated in FIG. 10.

Controller application 120 compensates for the low-frequency gain to adjust the bass level heard by the listener according to the listener's ear canal volume. The magnitude of the pressure response H_{P}_{_{EEP}}_{/U}_{_{DRV}}(ω) at low frequencies, below 100 Hz for instance, is then compared to a given value of reference, which may correspond to the magnitude of the same pressure response measured in the ear simulator which was used to tune the Harman target curve for in-ear headphones. The relationship between the voltage U_{DRV}(ω) and the pressure P_{EEP}(ω) at the ear entrance point can be written as

$$( \begin{matrix}{U}_{DRV} ( ω ) \\ {I}_{DRV} ( ω )\end{matrix} ) = ( \begin{matrix}{a}_{11} ( ω ) & {a}_{12} ( ω ) \\ {a}_{21} ( ω ) & {a}_{22} ( ω )\end{matrix} ) ( \begin{matrix}{P}_{EEP} ( ω ) \\ {P}_{EEP} ( ω ) / {Z}_{OEC} ( ω )\end{matrix} ) \qquad Equation 31$$

where Z_{OEC}(ω) is the open ear canal impedance at the ear entrance point

$${Z}_{OEC} ( ω ) = \frac{{P}_{EEP} ( ω )}{- {Q}_{EEP} ( ω )} = \frac{{c}_{11} ( ω ) + \frac{{c}_{12} ( ω )}{{Z}_{EC , LC} ( ω )}}{{c}_{21} ( ω ) + \frac{{c}_{22} ( ω )}{{Z}_{EC , LC} ( ω )}} \qquad Equation 32$$

Then the pressure response H_{P}_{_{EEP}}_{/U}_{_{DRV}}(ω) at the ear entrance point is written as

$${H}_{{P}_{EEP} / {U}_{DRV}} ( ω ) = \frac{1}{{a}_{11} ( ω ) + \frac{{a}_{12} ( ω )}{{Z}_{OEC} ( ω )}} \qquad Equation 33$$

The ratio of the magnitudes of the pressure responses H_{P}_{_{EEP}}_{/U}_{_{DRV}}(ω) in the user's ear vs ear simulator is multiplied to a reference gain of a bass shelf filter H_{BSF}(ω), which has been preliminarily defined for the closed ear volume of the ear simulator. For instance, a bass shelf filter with a cut-off frequency of 105 Hz is used in the Harman Target curve for in-ear headphones whose reference gain corresponds to the closed ear canal volume of a given ear simulator. In another implementation, the magnitudes of the pressure responses H_{P}_{_{EP}}_{/U}_{_{DRV}}(ω) of user and ear simulator are compared at low frequencies instead of the magnitudes of the pressure responses H_{P}_{_{EEP}}_{/U}_{_{DRV}}(ω).

Controller application 120 designs an individualized correction function H_{C}(ω) based on the transfer functions calculated in the previous steps and based on the estimated pressure response H_{P}_{_{DRP}}_{/U}_{_{DRV}}(ω) at the user's eardrum as follows

$${H}_{C} ( ω ) = {G}_{C} \frac{{H}_{LC} ( ω ) {H}_{BSF} ( ω ) {H}_{{P}_{DRP} / {P}_{EXT}} ( ω ) {H}_{BE} ( ω ) {H}_{TSF} ( ω )}{{H}_{{P}_{DRP} / {U}_{DRV}} ( ω )} \qquad Equation 34$$

In Equation 34, the leakage compensation transfer function is H_{LC}(ω), the transfer function from the external ear point to the ear tip is H_{P}_{_{DRP}}_{/P}_{_{EXT}}(ω), and the bass shelf filter is H_{BSF}(ω). H_{BE}(ω) is the steady-state blocked ear response of an external sound source to the pressure at the ear entrance point relative to the pressure at the center head in the absence of the head. This response includes the contributions of torso, head, and pinna. It can correspond to the measurement of the diffuse field response using an ear simulator, from a database, or from an individualized response obtained via measurement or interpolation processes. It can also correspond to the result of one or several combinations of head related transfer functions for different angles of the external sound source. For the Harman target curve, this response would correspond the steady-state response of a loudspeaker, which has an anechoically flat on-axis response with a smooth sound power measured at the ear entrance point of a head and torso simulator in a semi-reverberant listening room. Then, H_{TSF}(ω) is a treble shelf filter of predefined gain and cut-off frequency. For instance, a treble shelf filter with a cut-on frequency of 2.5 kHz is used in the Harman target curve for in-ear headphones whose reference gain corresponds to a given ear simulator. Finally, G_{C} is a correction gain to adjust the sound pressure at the drum reference point to a desired level.

For spatial audio playback, controller application 120 calculates individualized corrections. Similarly to target curves, the ear canal response could be corrected. Referring to Equation 34, some of these transfer functions can be bypassed or modified depending on how the audio input was recorded and processed. In the fitting of hearing aids, audiologists measure at the eardrum, using a probe tube microphone, which can cause some discomfort. In some implementations, the disclosed techniques could be employed as an alternate method to estimate the pressure at the user's eardrum, in a less invasive manner.

When using hear-through or transparency modes, a goal includes the user hearing the environmental sounds with the earphones in the user's ear as though through an open and unimpeded ear. An outer microphone records the ambient audio, then the recorded ambient audio is corrected, then the corrected audio is played into the ear. In one method of correction to achieve this transparency, a correction function H_{HT}(ω) is characterized during the design of an earbud and can also be controlled and characterized during production. H_{HT}(ω) is the correction to provide a transparent response in an optimization target such as an ear simulator. When in use by an individual user, further correction of H_{HT}(ω) by an adaptive hear-through filter provides personalized transparency. The hear-through filter may be tuned from the primary path between the reference outer microphone and error inner microphone of the earphone or between the reference outer microphone and the measured or estimated pressure at the user's eardrum, from the secondary path between the speaker and error inner microphone or between the speaker and the measured or estimated pressure at the eardrum, and from the feedback controller sensitivity function when active noise cancellation or occlusion removal is implemented. The filter coefficients are adjusted in-situ when the earphone is in the user's ear. Individualized hear-through correction uses the pressure estimated at the eardrum to update the feedforward filter coefficients.

In some embodiments, controller application 120 designs an individualized correction hear-through function H_{HT}(ω) based on the transfer functions calculated in the previous steps and based on the estimated pressure response H_{P}_{_{DRP}}_{/U}_{_{DRV}}(ω) at the user's eardrum as follows

$${H}_{HT} ( ω ) = {G}_{HT} \frac{{H}_{{P}_{DRP} / {P}_{EXT}} ( ω )}{{H}_{{P}_{DRP} / {U}_{DRV}} ( ω )} \qquad Equation 35$$

where G_{HT} is a gain to adjust the sound pressure at the drum reference point to a desired level. The input of the hear-through function H_{HT}(ω) is the pressure P_{MIC OUT}(ω) measured by the outer microphone.

In the case of ANC, personalization for an individual user uses the primary path between the reference outer microphone and the estimated pressure at the eardrum and secondary paths between the speaker and the estimated pressure at the user's eardrum and between the speaker and the inner microphone to update the filter coefficients of any or all of the playback path, the feedforward and feedback paths. The filter coefficients are adjusted in-situ when the earphone is in the user's ear. In some implementations, hearing aid or PSAP features can add to transparency an EQ or nonlinear processing based on the hearing ability of the individual, with parameters derived from a hearing test or from age-based assumptions. The equalization, nonlinear processing, and any other hearing enhancement processing uses as input the H_{HT}(ω) and H_{C}(ω) corrected ambient signals to provide the personalization.

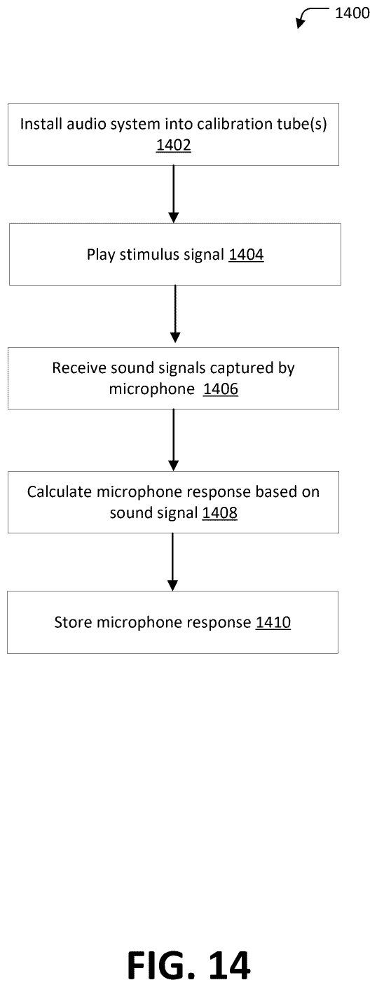

FIG. 14 is a flow diagram of method steps for determining a microphone acoustic response 132 of audio system 100, according to various embodiments. Although the method steps are described with respect to the embodiments of FIGS. 1-13, persons skilled in the art will understand that any system configured to perform the method steps, in any order, falls within the scope of the various embodiments.

As shown, a method 1400 begins at step 1402, at which the audio system 100 is installed into a calibration tube 208. The audio system 100 is installed into calibration tube 208 for calibration of the audio system 100, such as an earbud. The audio system 100 includes one or more microphones 150 within the calibration tube 208 for obtaining measurements of sound pressure and/or volume velocity near the ear tip 206 of audio system 100 within the calibration tube 208. The calibration tube 208 includes a calibration microphone 210 for detecting the characteristics of sound occurring within calibration tube 208. Calibration of audio system 100 using a calibration tube 208 is performed during production of the audio system 100 in some embodiments.

At step 1404, controller application 120 causes audio system 100 to play back a stimulus signal. The controller application 120 causes the one or more speakers 160 to play the stimulus signal within the calibration tube 208. In some embodiments, the stimulus signal includes a log swept sine chirp or another signal with sufficient spectral coverage throughout the audible frequency spectrum.

At step 1406, controller application 120 receives a sound signal captured by the one or more microphones 150 of the audio system 100 within the calibration tube 208. The sound signal captured by the one or more microphones 150 represents sound measurements captured by the one or more microphones 150. The sound measurements include sound pressure and volume velocity measurements, based on the stimulus signal, corresponding to sound occurring at or near ear tip 206 when audio system 100 is inserted into calibration tube 208.

At step 1408, controller application 120 calculates a microphone acoustic response 132 based on the sound signal received at step 1404. The calculated acoustic response is generated based on the acoustic impedance of the calibration tube in which the earbud is inserted as illustrated above by Equations 1-3, for example.

At step 1410, controller application 120 stores the microphone acoustic response 132 into the memory 114 of audio system 100. The microphone acoustic response 132 can be used by audio system 100 to generate ear canal response corrections 140 for a user.

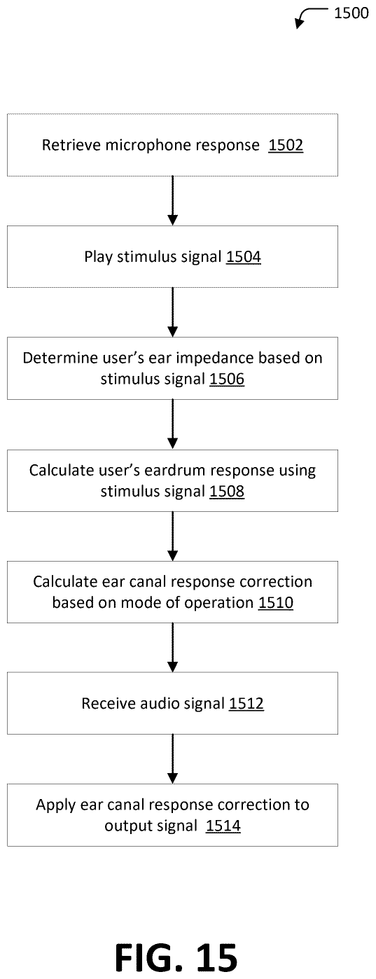

FIG. 15 is a flow diagram of method steps for determining ear canal response correction 140 corresponding to audio system 100, according to various embodiments. Although the method steps are described with respect to the embodiments of FIGS. 1-13, persons skilled in the art will understand that any system configured to perform the method steps, in any order, falls within the scope of the various embodiments.

At step 1502, control application 120 retrieves the microphone acoustic response 132 of the audio system 100. For example, control application 120 can retrieve the microphone acoustic response 132 computed by method 1400 and save in memory 114.

At step 1504, controller application 120 causes the audio system 100 to play a stimulus signal. The stimulus signal is played back via the one or more speakers 160. The stimulus signal is played back when the audio system 100 is worn by the user so that the stimulus signal is played back within the ear canal of the user.

At step 1506, controller application 120 determines the acoustic impedance of the user's ear canal based on a sound signal captured by the one or more microphones 150 in response to playback of the stimulus signal. Controller application 120 receives the sound signal from the one or more microphones 150 of audio system 100. As described above in the context of Equation 20, for example, the acoustic impedance of the user's ear canal is calculated based on the microphone acoustic response 132 and the sound signals.

At step 1508, controller application 120 calculates the acoustic response of the user's eardrum. The acoustic response of the user's eardrum is calculated based on the response of the microphone, the calculated acoustic impedance of the user's ear or ear canal, and the sound signal received via one or more microphones 150 as set forth by Equation 22, for example. The acoustic response of the user's eardrum is determined using the two-port network 300 that is generated based on the microphone acoustic response 132. In some examples, the two-port network 300 is generated based on the voltage and current applied to the one or more speakers 160 to generate the stimulus signal and pressures detected at the one or more microphones 150 and, for example, ear tip locations of an earbud.

At step 1510, controller application 120 calculates eardrum response corrections, or ear canal response correction 140, based on the mode of operation. As set forth by Equation 34, for example, the ear canal response correction 140 is calculated by controller application 120 based on the acoustic response of the user's eardrum that is calculated at step 1508.

At step 1512, controller application 120 receives an audio signal in the audio system 100. The audio signal represents audio that is being played back by audio system 100, such as voice, music, or any other audio source. Audio system 100 can receive the audio signal from another device that is connected to audio system 100, such as a vehicle audio system, a mobile device connected to audio system 100, a radio, a media server, the memory 114 of audio system 100, or another audio source.

At step 1514, controller application 120 applies, based on the ear canal response correction 140 and the microphone acoustic response 132, the ear canal response correction 140 to an output signal played back by the audio output device. The output signal represents the audio signal being played back by audio system 100 that is corrected using the ear canal response correction 140 generated by controller application 120.

In sum, the disclosed techniques include driving an audio output device to reproduce a stimulus signal when a wearable device is placed along an ear canal of a user. The disclosed techniques also include receiving a sound signal from a microphone based on the stimulus signal and determining, based on the sound signal and a calculated response of the microphone retrieved from a memory, one or more characteristics of the ear canal of the user. The one or more characteristics of the ear canal of the user include an ear canal impedance calculated based on the calculated acoustic response of the microphone and the sound signal. The disclosed techniques further include applying, based on the one or more characteristics of the ear canal, an ear canal response correction to an output signal played back by the audio output device.

At least one technical advantage of the disclosed techniques herein relative to the prior art is that, with the disclosed techniques, a quality of sound produced by an earbud can be tailored in accordance with different physical attributes of a user's ear canal and eardrum. Additionally, the sound can be tailored to a user without having to directly measure the response of a user's eardrum and without placing microphones or sensors on the eardrum of the user. Instead, the disclosed techniques customize the sound quality of an earbud in response to sound detected by one or more internal microphones of the earbud that serve other purposes, such as one or more microphones that facilitate active noise cancellation. Another advantage of the disclosed techniques is providing for practical measurement and characterization of individual ear canal behavior and prediction of actual acoustic response at user's eardrum. Calculating the acoustic response of the user's eardrum allows for the effects of a user's ear canal and eardrum on acoustic performance to be corrected and individualized. These technical advantages provide one or more technological improvements over prior art approaches.
1. In some embodiments, a computer-implemented method comprises driving an audio output device to reproduce a stimulus signal when a wearable device is placed along an ear canal of a user, receiving a sound signal from a microphone based on the stimulus signal, determining, based on the sound signal and a calculated response of the microphone retrieved from a memory, one or more characteristics of the ear canal of the user, wherein the one or more characteristics of the ear canal comprise an ear canal impedance, and applying, based on the one or more characteristics of the ear canal, an ear canal response correction to an output signal played back by the audio output device.
2. The computer-implemented method of clause 1, wherein the one or more characteristics of the ear canal of the user includes a frequency response at an ear drum of the user.
3. The computer-implemented method of clauses 1 or 2, wherein the wearable device comprises an earbud or a headphone.
4. The computer-implemented method of any of clauses 1-3, wherein the microphone of the wearable device is disposed within the ear canal of the user when the wearable device is worn by the user.
5. The computer-implemented method of any of clauses 1-4,wherein applying the ear canal response correction comprises performing active noise cancellation (ANC) for the audio output device based on an input from the microphone and the ear canal response correction.
6. The computer-implemented method of any of clauses 1-5, wherein the calculated response of the microphone is determined based on a calculated acoustic response of the microphone and an acoustic impedance of a calibration tube in which the wearable device is inserted.
7. The computer-implemented method of any of clauses 1-6, wherein the calculated acoustic response of the microphone is calculated using a two-port network model of the microphone inserted into the calibration tube.
8. The computer-implemented method of any of clauses 1-7, further comprising determining the acoustic impedance of the calibration tube using a two-port network model of the calibration tube with the wearable device inserted into the calibration tube.
9. The computer-implemented method of any of clauses 1-8, wherein the one or more characteristics of the ear canal further comprise a calculated acoustic response at an ear tip of the wearable device based on the ear canal impedance and the calculated acoustic response of the microphone.
10. The computer-implemented method of any of clauses 1-9, wherein the one or more characteristics of the ear canal further comprise an acoustic response of an eardrum of the user based on the calculated acoustic response at the ear tip of the wearable device and the stimulus signal.
11. The computer-implemented method of any of clauses 1-10, wherein the stimulus signal comprises a log swept sine chirp.
12. The computer-implemented method of any of clauses 1-11, wherein the stimulus signal comprises an audio signal with spectral coverage across an audible frequency range.
13. In some embodiments, one or more non-transitory computer-readable media store instructions that, when executed by one or more processors, cause the one or more processors to perform the steps of driving an audio output device to reproduce a stimulus signal when a wearable device is placed along an ear canal of a user, receiving a sound signal from a microphone based on the stimulus signal, determining, based on the sound signal and a calculated response of the microphone retrieved from a memory, one or more characteristics of the ear canal of the user, wherein the one or more characteristics of the ear canal comprises an ear canal impedance, and applying, based on the one or more characteristics of the ear canal, an ear canal response correction to an output signal played back by the audio output device.
14. The one or more non-transitory computer-readable media of clause 13, wherein the one or more characteristics of the ear canal of the user further comprises a frequency response at an ear drum of the user.
15. The one or more non-transitory computer-readable media of clauses 13 or 14, wherein the microphone of the wearable device is disposed within the ear canal of the user when the wearable device is worn by the user.
16. The one or more non-transitory computer-readable media of any of clauses 13-15, wherein applying the ear canal response correction comprises performing active noise cancellation (ANC) for the audio output device based on an input from the microphone and the ear canal response correction.
17. The one or more non-transitory computer-readable media of any of clauses 13-16, further comprising determining a calculated acoustic response of the microphone based on an acoustic impedance of a calibration tube in which the wearable device is inserted.
18. The one or more non-transitory computer-readable media of any of clauses 13-17, wherein the stimulus signal comprises a log swept sine chirp.
19. The one or more non-transitory computer-readable media of any of clauses 13-18, wherein the stimulus signal comprises at least one of a voltage or a current applied to a driver of the wearable device within the ear canal of the user.
20. In some embodiments, an audio system comprises one or more speakers, one or more microphones, a memory storing a controller application, and a processor coupled to the memory that, when executing the controller application, performs the steps of driving the one or more speakers to reproduce a stimulus signal when a wearable device is placed along an ear canal of a user, receiving a sound signal from the one or more microphones based on the stimulus signal, determining, based on the sound signal and a calculated response of the one or more microphones retrieved from the memory, one or more characteristics of the ear canal of the user, wherein the one or more characteristics of the ear canal comprises an ear canal impedance, and applying, based on the one or more characteristics of the ear canal, an ear canal response correction to an output signal played back by the one or more speakers.

Any and all combinations of any of the claim elements recited in any of the claims and/or any elements described in this application, in any fashion, fall within the contemplated scope of the present invention and protection.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments.

Aspects of the present embodiments can be embodied as a system, method or computer program product. Accordingly, aspects of the present disclosure can take the form of an entirely hardware embodiment, an entirely software embodiment (including firmware, resident software, micro-code, etc.) or an embodiment combining software and hardware aspects that can all generally be referred to herein as a “module,” a “system,” or a “computer.” In addition, any hardware and/or software technique, process, function, component, engine, module, or system described in the present disclosure can be implemented as a circuit or set of circuits. Furthermore, aspects of the present disclosure can take the form of a computer program product embodied in one or more computer readable medium having computer readable program code embodied thereon.

Any combination of one or more computer readable medium can be utilized. The computer readable medium can be a computer readable signal medium or a computer readable storage medium. A computer readable storage medium can be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium can be any tangible medium that can contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions can be provided to a processor of a general-purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors can be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams can represent a module, segment, or portion of code, which comprises one or more executable instructions for implementing the specified logical function. It should also be noted that, in some alternative implementations, the functions noted in the block can occur out of the order noted in the figures. For example, two blocks shown in succession may, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure can be devised without departing from the basic scope thereof, and the scope thereof is determined by the claims that follow.

What is claimed is:

1. A computer-implemented method, comprising:
driving an audio output device to reproduce a stimulus signal when a wearable device is placed along an ear canal of a user;
receiving a sound signal from a microphone based on the stimulus signal;
determining, based on the sound signal and a calculated response of the microphone retrieved from a memory, one or more characteristics of the ear canal of the user, wherein the one or more characteristics of the ear canal comprise an ear canal impedance; and
applying, based on the one or more characteristics of the ear canal, an ear canal response correction to an output signal played back by the audio output device.

2. The computer-implemented method of claim 1, wherein the one or more characteristics of the ear canal of the user includes a frequency response at an ear drum of the user.

3. The computer-implemented method of claim 1, wherein the wearable device comprises an earbud or a headphone.

4. The computer-implemented method of claim 1, wherein the microphone of the wearable device is disposed within the ear canal of the user when the wearable device is worn by the user.

5. The computer-implemented method of claim 4, wherein applying the ear canal response correction comprises performing active noise cancellation (ANC) for the audio output device based on an input from the microphone and the ear canal response correction.

6. The computer-implemented method of claim 1, wherein the calculated response of the microphone is determined based on a calculated acoustic response of the microphone and an acoustic impedance of a calibration tube in which the wearable device is inserted.

7. The computer-implemented method of claim 6, wherein the calculated acoustic response of the microphone is calculated using a two-port network model of the microphone inserted into the calibration tube.

8. The computer-implemented method of claim 6, further comprising determining the acoustic impedance of the calibration tube using a two-port network model of the calibration tube with the wearable device inserted into the calibration tube.

9. The computer-implemented method of claim 1, wherein the one or more characteristics of the ear canal further comprise a calculated acoustic response at an ear tip of the wearable device based on the ear canal impedance and the calculated acoustic response of the microphone.

10. The computer-implemented method of claim 9, wherein the one or more characteristics of the ear canal further comprise an acoustic response of an eardrum of the user based on the calculated acoustic response at the ear tip of the wearable device and the stimulus signal.

11. The computer-implemented method of claim 1, wherein the stimulus signal comprises a log swept sine chirp.

12. The computer-implemented method of claim 1, wherein the stimulus signal comprises an audio signal with spectral coverage across an audible frequency range.

13. One or more non-transitory computer-readable media storing instructions that, when executed by one or more processors, cause the one or more processors to perform the steps of:
driving an audio output device to reproduce a stimulus signal when a wearable device is placed along an ear canal of a user;
receiving a sound signal from a microphone based on the stimulus signal;
determining, based on the sound signal and a calculated response of the microphone retrieved from a memory, one or more characteristics of the ear canal of the user, wherein the one or more characteristics of the ear canal comprises an ear canal impedance; and
applying, based on the one or more characteristics of the ear canal, an ear canal response correction to an output signal played back by the audio output device.

14. The one or more non-transitory computer-readable media of claim 13, wherein the one or more characteristics of the ear canal of the user further comprises a frequency response at an ear drum of the user.

15. The one or more non-transitory computer-readable media of claim 13, wherein the microphone of the wearable device is disposed within the ear canal of the user when the wearable device is worn by the user.

16. The one or more non-transitory computer-readable media of claim 15, wherein applying the ear canal response correction comprises performing active noise cancellation (ANC) for the audio output device based on an input from the microphone and the ear canal response correction.

17. The one or more non-transitory computer-readable media of claim 13, further comprising determining a calculated acoustic response of the microphone based on an acoustic impedance of a calibration tube in which the wearable device is inserted.

18. The one or more non-transitory computer-readable media of claim 13, wherein the stimulus signal comprises a log swept sine chirp.

19. The one or more non-transitory computer-readable media of claim 13, wherein the stimulus signal comprises at least one of a voltage or a current applied to a driver of the wearable device within the ear canal of the user.

20. An audio system comprising:
one or more speakers;
one or more microphones;
a memory storing a controller application; and
a processor coupled to the memory that, when executing the controller application, performs the steps of:
driving the one or more speakers to reproduce a stimulus signal when a wearable device is placed along an ear canal of a user;
receiving a sound signal from the one or more microphones based on the stimulus signal;
determining, based on the sound signal and a calculated response of the one or more microphones retrieved from the memory, one or more characteristics of the ear canal of the user, wherein the one or more characteristics of the ear canal comprises an ear canal impedance; and
applying, based on the one or more characteristics of the ear canal, an ear canal response correction to an output signal played back by the one or more speakers.
